(19) United States
(12) Patent Application Publication
(10) Pub. No.: US 2026/0290987 A1
(43) Pub. Date: Sep. 24, 2026

(54) SYSTEMS FOR BATTERY PACKS

(71) Applicant: Ford Global Technologies, LLC, Dearborn, MI (US)

(72) Inventors: John Marshall Penney, Livonia, MI (US); Douglas Christian Lipp, Ann Arbor, MI (US)

(21) Appl. No.: 19/085,962

(22) Filed: Mar. 20, 2025

(51) Int. Cl. H01M 50/296; H01M 50/204; H01M 50/289; H01M 50/516; H01M 50/249

(52) U.S. Cl. CPC H01M 50/296; H01M 50/204; H01M 50/289; H01M 50/516; H01M 50/249

(57) ABSTRACT

Methods and systems are provided for a battery pack. The battery pack includes cells grouped in pairs. The battery pack further includes thermal barriers and compressible layers interposed between the pairs. At least some tabs of the cells are directly welded to each other rather than to a corresponding bus bar.

### FIELD

The present description relates generally to battery packs.

### BACKGROUND/SUMMARY

Battery packs may be used in various applications, such as vehicles including hybrid and electric vehicles or stationary systems, for energy storage. A battery pack may include a plurality of cells, thermal barriers, and compressible layers (e.g., foam or other flexible layers). The thermal barriers and the compressible layers may be interposed between pairs of adjacent cells. The plurality of cells may be interconnected via tabs thereof. Conventionally, the tabs of adjacent cells may be welded to bus bars. The cell tabs may extend out of a support frame housing the cells, and the bus bars may be located outside of the frame. Some sets of cell tabs may bridge the compressible layers and thermal barriers to couple the cells physically separated by the compressible layers and thermal barriers.

A cell linking architecture where the cells are linked with reduced bus bars (e.g., with fewer bus bars or without bus bars) may reduce parts and manufacturing processes to produce a battery pack. Thus, a battery pack herein disclosed may comprise a cell stack including cells grouped in pairs, and thermal barriers and compressible layers interposed between the pairs, where a first tab of each of the cells is directly welded to an adjacent first tab of the corresponding cell pair. In this way, at least some of the tabs are directly welded to each other rather than to a corresponding bus bar. In one example, some of the tabs may be directly welded and the other tabs may be welded to corresponding bus bars. In another example, all of the tabs may be directly welded to each other such that the bus bars for coupling cells may be completely eliminated.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an example system wherein a battery pack in accordance with the present disclosure may be used.

FIG. 2 shows a first example of a cell stack.

FIGS. 3A and 3B show schematics of a battery pack.

FIG. 4 shows an example of a frame of the battery pack.

FIG. 5 shows a schematic of a subassembly of the battery pack including the frame and a cell stack, such one of the cell stacks of FIGS. 2-3B, housed therein.

FIG. 6 shows a schematic of the battery pack comprising a plurality of the subassembly of FIG. 5.

FIG. 7 shows a flowchart of a method for manufacturing a battery pack in accordance with the present disclosure.

FIG. 8 shows a battery pack.

FIG. 9 shows a first end of the battery pack.

FIG. 10 shows a second end of the battery pack.

FIG. 11 shows a subassembly of the battery pack.

### DETAILED DESCRIPTION

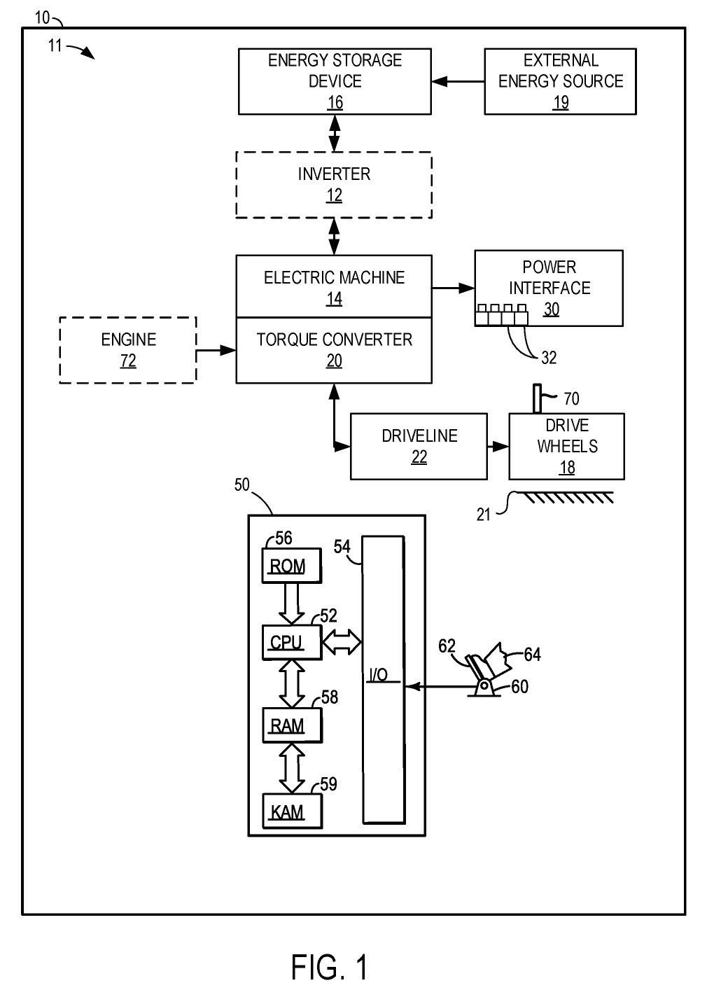

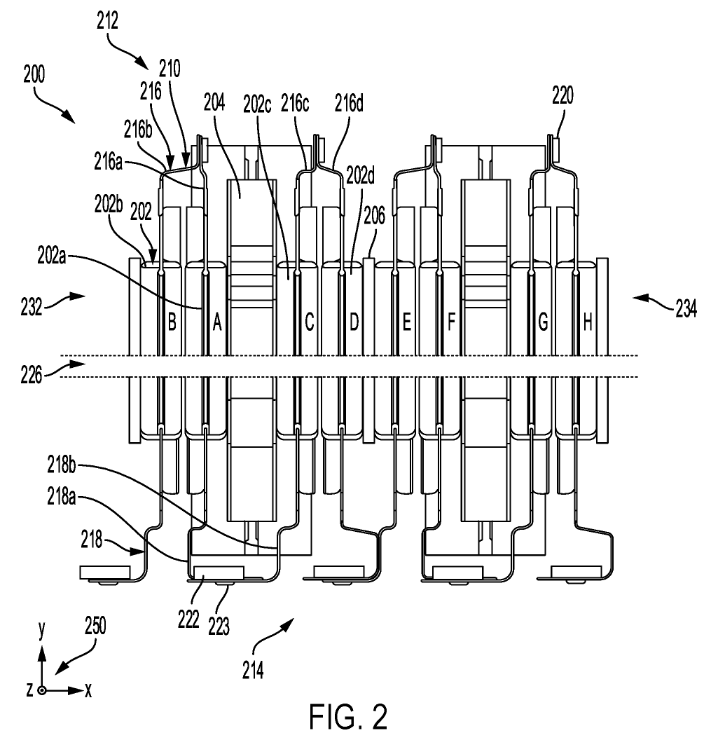

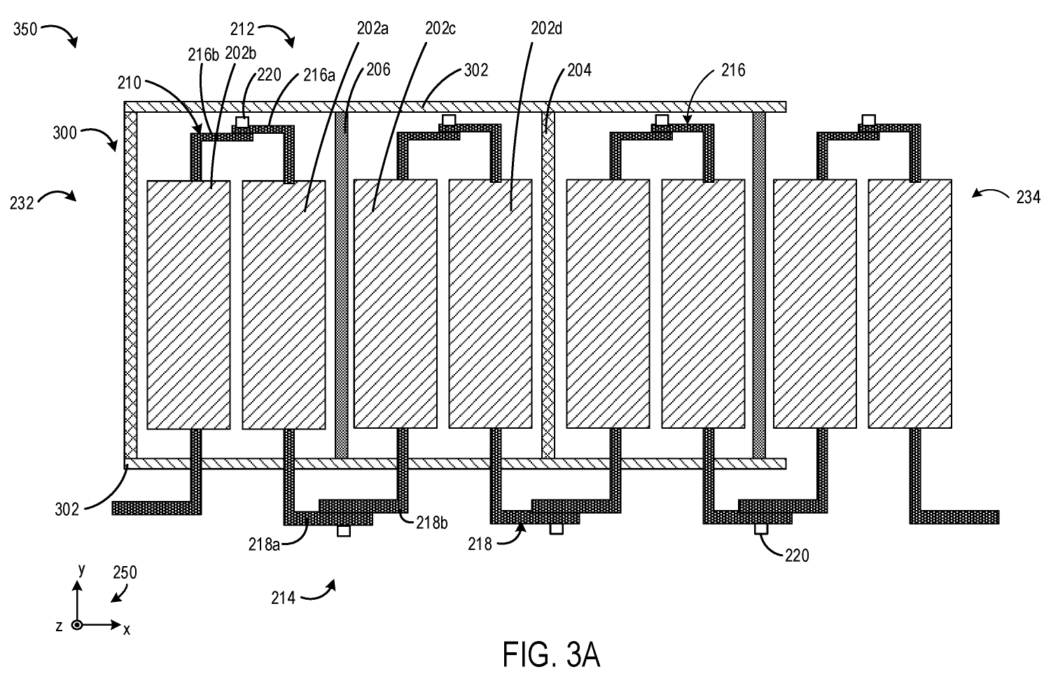

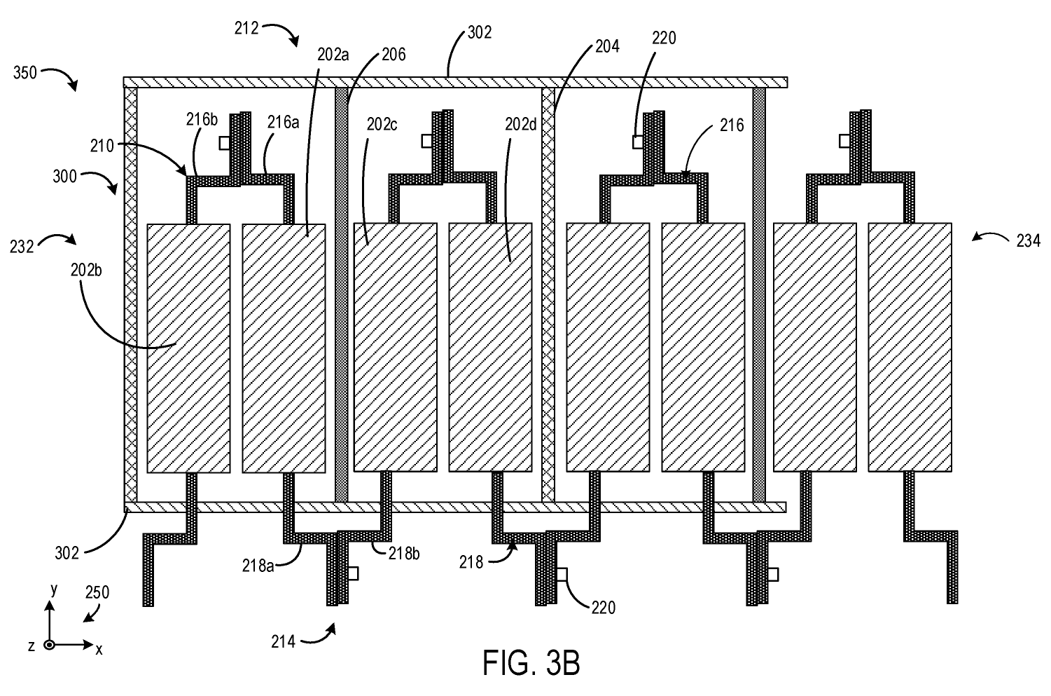

The following description provides systems and methods related to battery packs. Specifically, cell stacking and coupling architecture of the battery packs is described herein. The battery pack of the present disclosure may be used for energy storage. For example, the battery pack may be included in a vehicle, such as a vehicle shown schematically in FIG. 1, or a stationary system. The battery pack may comprise a cell stack housed within a frame. The cell stack may include a plurality of cells, compressible layers (e.g., foam layers), and thermal barriers stacked together. In at least some examples, the thermal barriers may be integral with the frame. The cells may be coupled to each other via tabs thereof. The tabs may be welded to bus bars or directly to each other to couple the corresponding cells. Examples of cell stacks are provided in FIGS. 2-3B, where the tabs are configured differently in each of the examples. Specifically, the tabs are coupled by a combination of welding to bus bars and direct welding in the example of FIG. 2, and all of the tabs are coupled directly to each other without bus bars in the example of FIGS. 3A and 3B. By directly welding at least some of the tabs, at least some bus bars may be eliminated from the battery pack (e.g., from one or both sides of the battery pack). In either example, parts demanded and manufacturing complexity may be reduced due to at least some sets of cell tabs being coupled without a bus bar.

As noted, some cell tabs may be welded pre-assembly (e.g., before assembling the cell stack with the frame) and may not protrude through the frame. Therefore, tab bending operations may be reduced. Moreover, tolerance stackup of the frame may be simplified by reducing (e.g., eliminating some or all) bus bars for coupling the tabs. Additionally, elimination of at least some bus bars may open space along the frame, allowing for increased surface area of venting, thereby increasing thermal management capabilities of the battery pack.

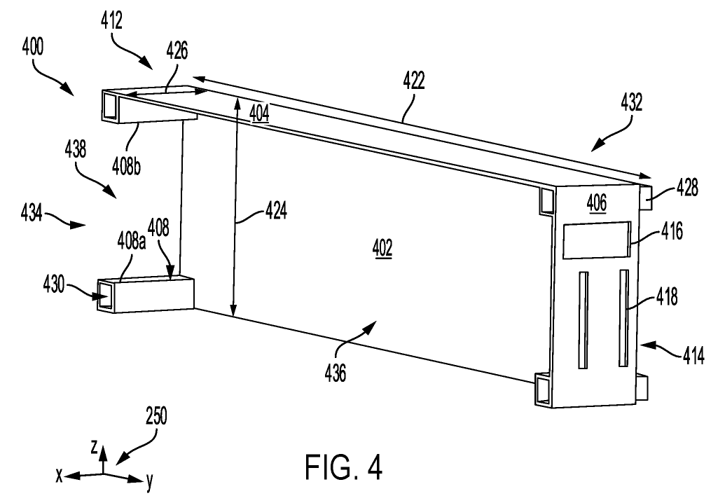

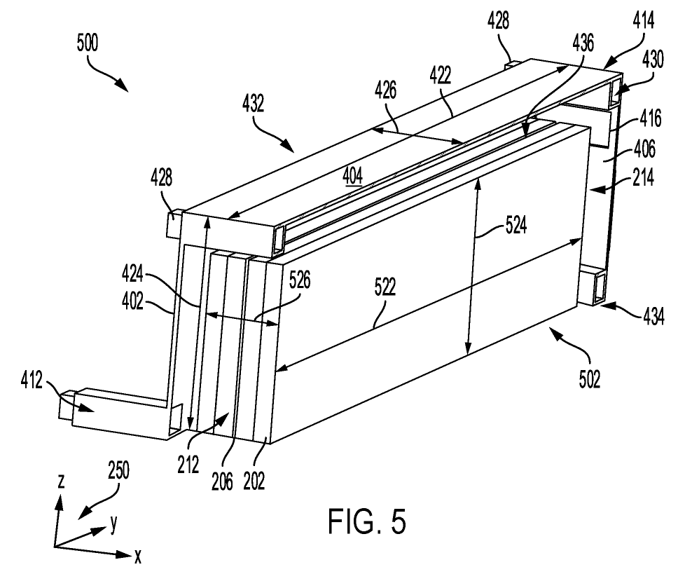

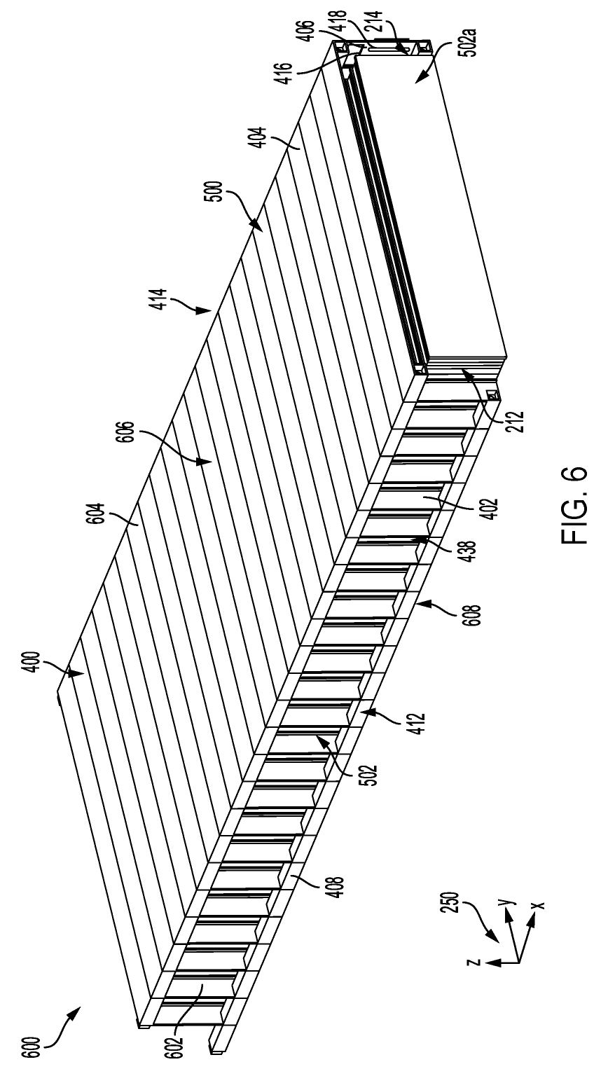

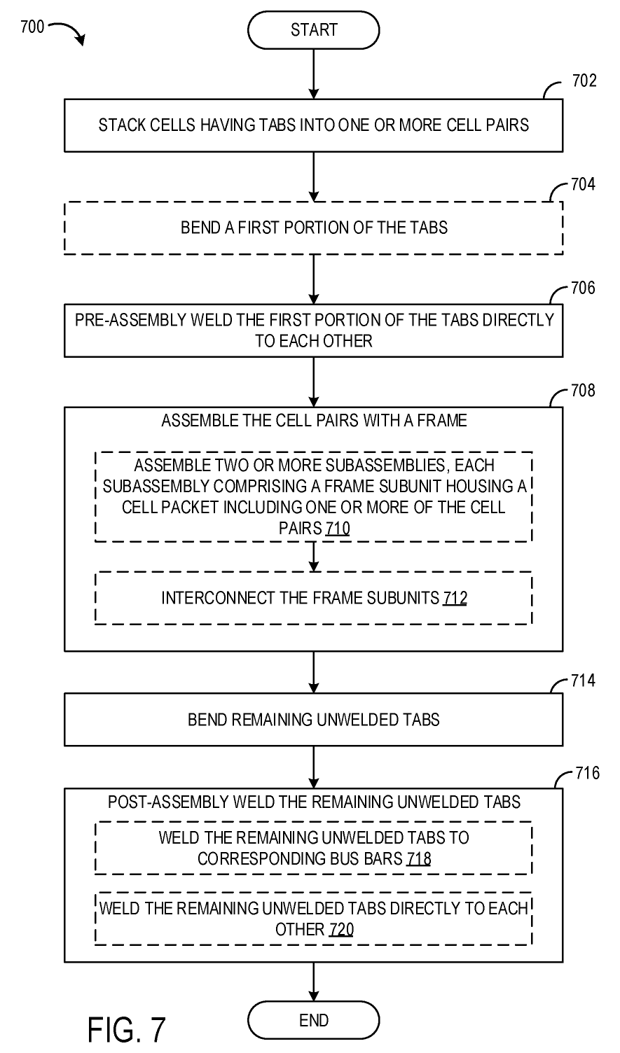

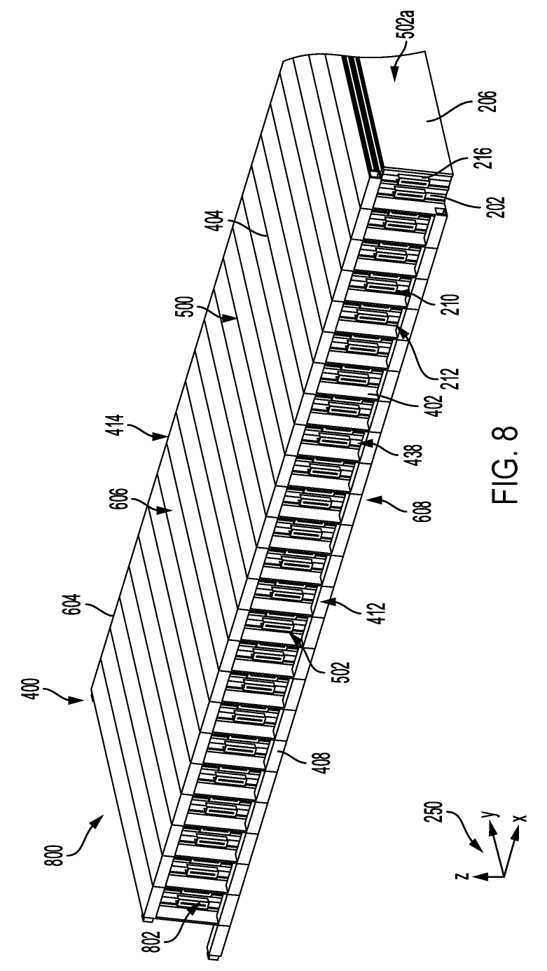

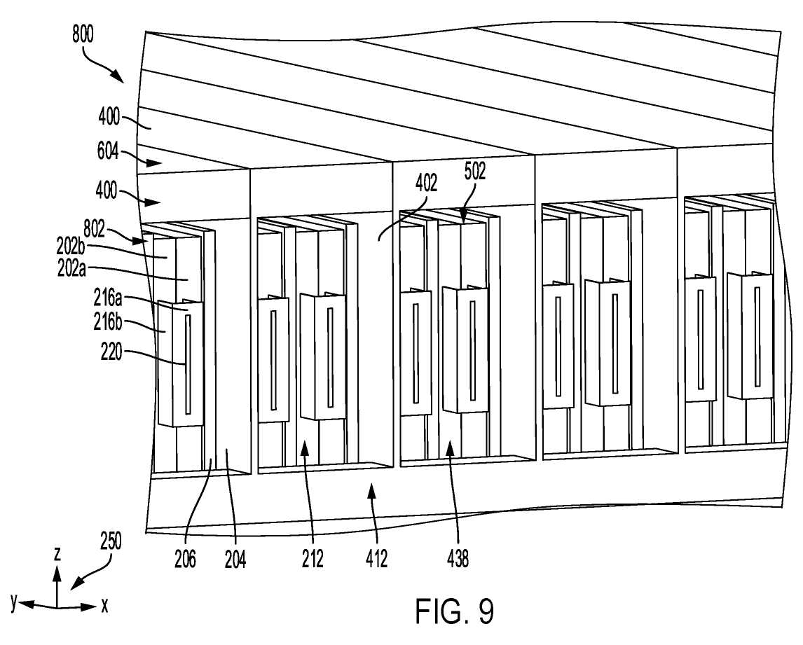

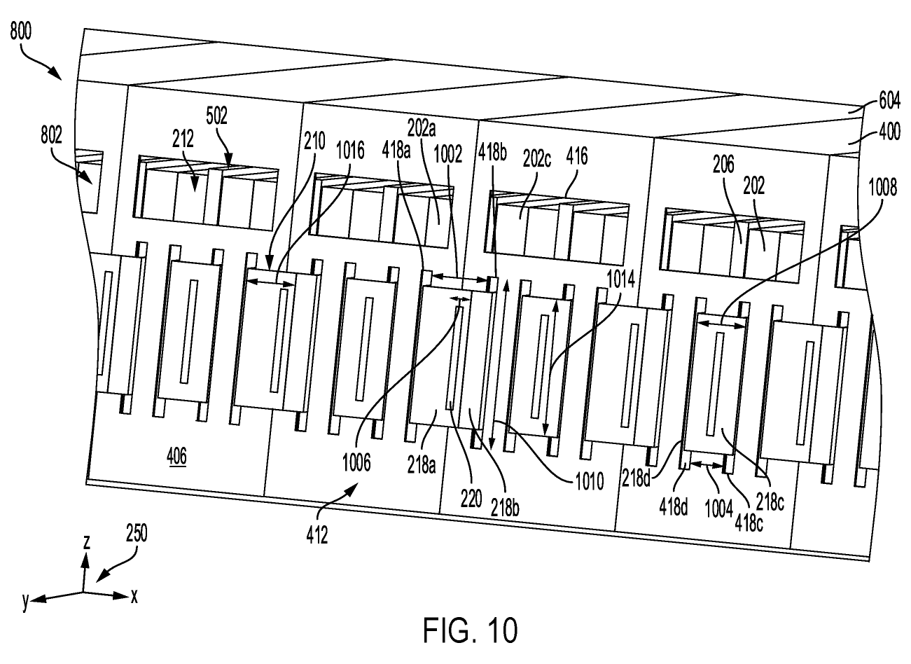

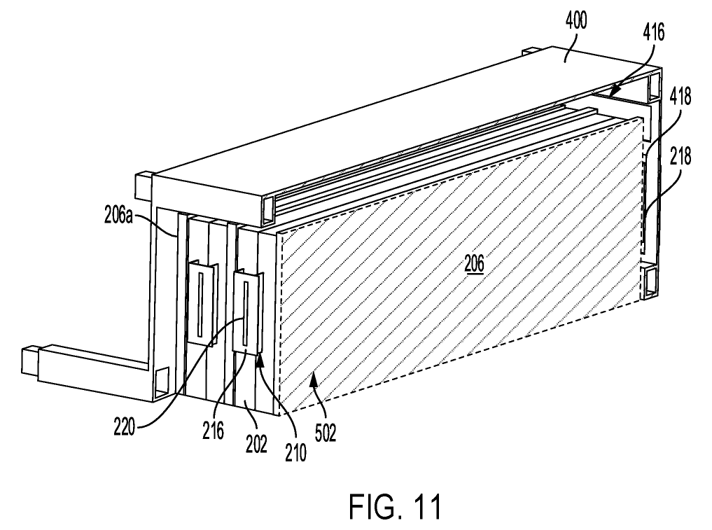

In at least some examples, the battery pack may comprise a plurality of subassemblies, each subassembly including a frame subunit (e.g., a portion of the frame) and a cell packet (e.g., a portion of the cell stack) housed therein. An example of a frame subunit of the battery pack is shown in FIG. 4. An example of a subassembly comprising the frame subunit of FIG. 4 is shown in FIG. 5. A battery pack comprising a plurality of the subassemblies of FIG. 5 is shown in FIG. 6. An example of a battery pack where all of the tabs are directly welded to each other is shown in FIG. 8. A first side and a second side of the battery pack of FIG. 8 are respectively shown in FIGS. 9 and 10. A subassembly of the battery pack of FIG. 8 is shown in FIG. 11. A flowchart of a method for forming a battery pack in accordance with the present disclosure is shown in FIG. 7. At least some of the tabs may be directly welded to each other prior to assembly of the cell stack with the frame, reducing post-assembly tab bending and welding operations, and therefore further decreasing manufacturing complexity. Further, reducing bus bars may reduce a packing volume of the battery pack and allow for increased venting surface area.

Turning now to FIG. 1, an example of a vehicle 10 with a propulsion system 11 (e.g., electric propulsion system) is shown. Propulsion system 11 includes an electric machine 14 (e.g., energy conversion device). Electric machine 14 is electrically coupled to an energy storage device 16, in some examples via an inverter 12. The energy storage device 16 may include a battery pack in accordance with the present disclosure, described further below in regard to FIGS. 2-7.

In some examples, vehicle 10 may be a hybrid vehicle with multiple sources of torque available to drive wheels 18. In other examples, vehicle 10 is a conventional vehicle with only an engine 72, or an electric vehicle with only electric machine(s) 14. In examples where vehicle 10 comprises engine 72, engine 72 may have an output coupled to torque converter 20 and may be incorporated into the axle of vehicle 10. Engine 72 may be controlled via controller 50. Both engine 72 and electric machine 14 may act as movers to drive vehicle 10. For example, vehicle 10 may be a hybrid vehicle. In examples including engine 72, rotational energy in the form of torque from engine 72 or other rotational and mechanical energy from components may be converted into electrical energy by electric machine 14. The output of electric machine 14 to torque converter 20 may act as input for the transfer and transformation of torque into electrical energy during hybrid operations.

Electric machine 14 can be operated to convert mechanical energy received from a driveline 22 into an energy form suitable for storage by the energy storage device 16 (e.g., provide a generator operation). Electric machine 14 can also be operated to supply an output (power, work, torque, speed, etc.,) to drive wheels 18 (e.g., provide a motor operation). It should be appreciated that electric machine 14 may, in some embodiments, function only as a motor, only as a generator, or both a motor and generator, among various other components used for providing the appropriate conversion of energy between the energy storage device and drive wheels 18. For instance, electric machine 14 may include a motor, a generator, integrated starter generator, starter alternator, among others and combinations thereof.

Energy storage device 16 may include a battery, a capacitor, inductor, or other electric energy storage device. For example, energy storage device 16 may include a battery pack in accordance with the present disclosure. Energy storage device 16 may be selectively coupled to an external energy source 19. For example, energy storage device 16 device may be periodically coupled to a charging station (e.g., commercial or residential charging station), portable energy storage device, etc., to allow energy storage device 16 to be recharged.

Electric machine 14 is coupled to a torque converter 20. Torque converter 20 is a fluid coupling designed to transfer rotational input from electric machine 14 to driveline 22. Driveline 22 includes a transmission with gearing and other suitable mechanical components (e.g., a gearbox, axles, transfer cases, etc.) designed to transfer rotational motion to drive wheels 18. Drive wheels 18 may be supported by and drive vehicle 10 across a surface 21. Torque converter 20 and electric machine 14 are depicted as an interconnected unit. However, in other examples, torque converter 20 and electric machine 14 may include discrete enclosures.

Electric machine 14 may include one or more clutches designed to selectively rotationally couple the machine’s rotor to torque converter 20. For instance, the clutch or clutches may each include plates, splines, and/or other suitable mechanical components allowing the electric machine 14 to be rotationally connected as well as disconnected from the engine 72 or the torque converter 20.

The depicted connections between electric machine 14, driveline 22, and drive wheels 18 indicate transmission of mechanical energy from one component to another, whereas the connections between electric machine 14 and energy storage device 16 may indicate transmission of a variety of energy forms such as electrical, mechanical, etc. For example, torque may be transmitted from electric machine 14 to vehicle drive wheels 18 via driveline 22. As described above, electric machine 14 may be configured to operate in a generator mode and/or a motor mode. In a generator mode, propulsion system 11 receives some or all of the output from electric machine 14, which reduces the amount of drive output delivered to drive wheels 18, or the amount of wheel caliper torque to drive wheels 18. Such operation may be employed, for example, to achieve energy efficiency gains through energy recovery, increased engine efficiency (if included), etc. Further, the output received by electric machine 14 may be used to charge an energy storage device 16 via the inverter 12. In motor mode, electric machine 14 may supply mechanical output to driveline 22, for example by using electrical energy stored in energy storage device (e.g., an electric battery) and provided to the electric machine 14 via the inverter 12. Additionally, an engine may supply rotational output to driveline 22, in some instances.

Electric machine 14 may also be used to deliver electrical energy to external, auxiliary devices during power take-off. Electric machine 14 may run during power take-off but drive wheels 18 are not in motion, allowing power output from electric machine 14 to be directed at least partially towards operating the auxiliary devices. Vehicle 10 may include a power interface 30 arranged along an electrical circuit of vehicle 10. The power interface may have a plurality of power outlets 32, each outlet electrically coupled to electric machine 14, and plugging the auxiliary devices into the plurality of outlets allows power to be supplied to the auxiliary devices. The arrow extending between electric machine 14 and power interface 30 indicates the transfer of electrical energy therebetween.

Controller 50 receives signals from various sensors and employs various actuators to adjust vehicle operation based on the received signals and instructions stored in non-transitory memory of the controller 50. Specifically, controller 50 is shown in FIG. 1 as a conventional microcomputer including: microprocessor unit 52, input/output ports 54, read-only memory 56, random access memory 58, keep alive memory 59, and a data bus. Controller 50 is configured to receive various signals from sensors coupled to propulsion system 11 and send command signals to actuators in components in vehicle 10, such as the electric machine 14. Additionally, the controller 50 is also configured to receive pedal position from a pedal position sensor 60 coupled to a pedal 62 actuated by a user 64. Therefore, in one example, controller 50 may receive a pedal position signal and adjust actuators in electric machine 14 based the pedal position signal to vary the rotational output of electric machine 14. The sensors communicating with controller 50 may include an electric machine sensor (e.g., resolver or Hall effect sensor for sensing a rotor position of the electric machine), and wheel speed sensor 70, etc. Controller 50 may adjust an output voltage of the inverter 12, or other aspects of current transferred between the energy storage device 16, the inverter 12, and the electric machine 14.

The energy storage device 16 may include a battery pack in accordance with the present disclosure, as noted above. The battery pack may include one or more of a plurality of cells, a plurality of compressible layers, and a plurality of thermal barriers stacked in a pattern to form a cell stack. The cells may be coupled in series via tabs of the cells being welded, with at least some tabs being welded directly to each other rather than to a bus bar as described further below. The battery pack of the present disclosure may be included in other systems, such as stationary systems, rather than a vehicle such as the vehicle 10, in other examples.

Turning to FIG. 2, a first example of a cell stack 200 including a plurality of cells 202 having tabs 210 is shown. A set of reference axes 250, including an x-axis, a y-axis, and a z-axis, are provided in FIG. 2, as well as FIGS. 3A-6, for comparison of the orientations illustrated therein. The x-axis may be a stacking axis wherealong the cells 202 are stacked. For example, the cells 202 may be oriented in y-z planes, perpendicular to the x-axis. Additionally or alternatively, the x-axis may be a lateral or side-to-side axis (e.g., extending between a first side 212 and a second side 214). Additionally or alternatively, the y-axis may be a longitudinal or end-to-end axis (e.g., extending between a first end 232 and a second end 234).

In addition to the cells 202 having tabs 210, the cell stack 200 may further include one or more thermal barriers 204. The thermal barriers 204 may be constructed of a thermally insulating material. In this way, cells 202 positioned on opposite sides of the thermal barriers 204 may be thermally insulated from one another. Conversely, heat may flow freely between cells not separated, for example by one of the thermal barriers 204. The thermal barriers 204 may be integral with a frame of a battery pack comprising the cell stack 200, as described further below.

The cell stack 200 may further include one or more compressible layers 206. For example, the compressible layers 206 may be constricted of a foam material. The compressible layers 206 may absorb shock, protecting the cells 202 from degradation due to vibration or other movement and increasing mechanical stability of the cell stack 200. Additionally or alternatively, the compressible layers 206 may hold the cells 202 in place by providing structure between the cells 202. Additionally or alternatively, the compressible layers 206 may be flexible to allow expansion and contraction of the cells 202. Additionally or alternatively, the compressible layers 206 may allow for compression of the cell stack 200 for increased durability of the cells 202.

The cells 202, the thermal barriers 204, and the compressible layers 206 may be stacked between the first end 232 and the second end 234. The view shown in FIG. 2 may be of a portion of the cell stack for detail, and in practice, the cell stack 200 may comprise more cells, thermal barriers 204, and/or compressible layers 206 than shown such that the distance between the first end 232 and the second end 234 relative to the scale of the cells 202 may be longer in practice than shown. Further, a break 226 is included in FIG. 2 to allow focus on sides where the tabs 210 are located, including the first side 212 and the second side 214. A midsection of the cell stack 200 which is located in the break 226 and not included in FIG. 2 may be continuous with the portions shown. Thus, a distance between the first side 212 and the second side 214 relative to the scale of the cells 202 may be greater than shown in FIG. 2.

The cells 202 may be grouped into cell pairs. A cell pair may include two of the cells 202 positioned in face-sharing contact. The thermal barriers 204 and the compressible layers 206 may be interposed between adjacent cell pairs. In one example, cell pair may be physically separated from the other cell pairs by a compressible layer 206 and/or a thermal barrier 204. A pattern of cells 202 (e.g., cell pairs), thermal barriers 204, and compressible layers 206 may repeat throughout the cell stack 200. For example, each cell pair may be interposed between one of the compressible layers 206 and one of the thermal barriers 204. Specifically, a first cell of a cell pair may be in face-sharing contact with one of the compressible layers 206, and a second cell of the same cell pair may be in face-sharing contact with one of the thermal barriers 204. Additionally or alternatively, between two adjacent thermal barriers 204 (e.g., between two thermal barriers 204 without another thermal barrier therebetween), there may be two pairs of the cells 202 separated by one of the compressible layers 206. Additionally or alternatively, between two adjacent compressible layers 206 (e.g., between two compressible layers 206 without another compressible layer therebetween), there may be two pairs of the cells 202 separated by one of the thermal barriers 204. In some examples, there may be spaces between one or more of cells 202 of the same cell pair, cells 202 and thermal barriers 204, and cells 202 and compressible layers 206. In such examples, components described above as being in face-sharing contact may be directly adjacent (e.g., separated only by the space) rather than in face-sharing contact. As one example, a cell pair may include two cells 202 directly adjacent to each other with a space (e.g., air gap) therebetween.

In other examples, there may be different patterns of cells 202, compressible layers 206, and thermal barriers 204. For example, the cells 202 may be grouped in threes, or more. Additionally or alternatively, there may be more than one compressible layer 206 interposed between adjacent thermal barriers 204. Additionally or alternatively, there may be more than one thermal barrier 204 interposed between adjacent compressible layers 206. Additionally or alternatively, there may be more or fewer than four cells 202 interposed between adjacent thermal barriers 204. Additionally or alternatively, there may be more or fewer than four cells 202 interposed between adjacent compressible layers 206.

The tabs 210 may be configured to couple the cells 202. More specifically, the cells 202 may be coupled in series via the tabs 210. Further, there may not be any cells 202 connected in parallel. Thus, the cell stack 200 may be a 1P cell string.

The cells 202 may each include two or more of the tabs 210 for coupling to other cells 202. For example, the tabs 210 of each of the cells 202 may include a first tab 216 at the first side 212 of the cell stack 200 and a second tab 218 at the second side 214 of the cell stack 200. The first side 212 may be opposite the second side 214. For example, the first side 212 may be at a relatively positive y-position, and the second side 214 may be at a relatively negative y-position. The first tabs 216 and the second tabs 218 may protrude opposite from one another across the cells 202. For example, the first tabs 216 may protrude in a positive y-direction and the second tabs 218 may protrude in a negative y-direction.

The first tabs 216 may be coupled in pairs and the second tabs 218 may be coupled in pairs. For example, a first first tab 216a of a first cell 202a may be coupled to a second first tab 216b of a second cell 202b adjacent and to the left of the first cell 202a. A first second tab 218a of the first cell 202a may be coupled to a second second tab 218b of a third cell 202c adjacent and to the right of the first cell 202a. A third first tab 216c of the third cell 202c may be coupled to a fourth first tab 216d of a fourth cell 202d adjacent and to the right of the third cell, and so on. In this way, a wave or zig-zag electrical pathway may be formed through the cells 202 and the tabs 210, coupling the cells 202 in series with each other.

To couple cells 202 of different cell pairs located opposite across one of the compressible layers 206 or thermal barriers 204 (e.g., the second cell 202b and the third cell 202c), the corresponding tabs 210 (e.g., first second tab 218a and second second tab 218b) may bridge the compressible layer 206 or thermal barrier 204 positioned therebetween. For example, the second tabs 218 bridge the thermal barriers 204 and compressible layers 206 to couple cells 202 of different cell pairs. To couple cells 202 not separated by one of the compressible layers 206 or thermal barriers 204 (e.g., cells 202 of the same cell pair such as the first cell 202a and the second cell 202b or the third cell 202c and the fourth cell 202d), the corresponding tabs 210 (e.g., the first first tab 216a and the second first tab 216b) may not bridge either a thermal barrier 204 nor a compressible layer 206. For example, the first tabs 216 couple cells 202 of in their corresponding cell pairs and thus do not bridge the thermal barriers 204 or the compressible layers 206. In this way, the first tab 216 of each of the cells 202 is directly welded to an adjacent first tab of the corresponding cell pair, and a second tab 218 of each of the cells is directly welded to an adjacent second tab of a different cell pair than the corresponding cell pair. The second tab and the adjacent second tab bridge one of the compressible layers and thermal barriers.

In at least some previous examples of battery packs, all cell pairs thereof may be coupled via a bus bar welded to corresponding cell tabs. In a battery pack of the present disclosure, at least some of the tabs may be coupled without a bus bar. More specifically, in a battery pack of the present disclosure comprising the cell stack 200, the tabs 210 may be coupled to each other via a combination of bus bars 222 and direct welds 220. That is, some of the tabs 210 may be coupled via one of the bus bars 222 and others of the tabs 210 may be directly welded to each other without a bus bar. Pairs of the tabs 210 coupled without a bus bar may be coupled by welding the tabs 210 together directly. Pairs of the tabs 210 coupled via a bus bar 222 may each be welded to the bus bar 222, as indicated by a weld bead 223 at each of the bus bars 222, rather than welded to each other directly. For example, pairs of the first tabs 216 may be coupled without bus bars. Additionally, pairs of the second tabs 218 may be coupled with a bus bar. In this way, at least some of the tabs 210 are coupled without a bus bar. Specifically, in one example, a first portion of the tabs 210 may be directly welded to other tabs (e.g., without a bus bar), and a second portion of the tabs 210 may be coupled to each other via a bus bar such as the bus bar 222, where the first portion may be located at the first side 212 and the second portion may be located at the second side 214.

Pairs of tabs 210 bridging (e.g., second tabs 218 at the second side 214) and not bridging (e.g., first tabs 216 at the first side 212) the thermal barriers 204 and compressible layers 206 may be shaped differently from each other. Additionally or alternatively, pairs of tabs 210 coupled with and without the bus bars 222 may be shaped differently from each other. For example, pairs of tabs 210 that bridge (e.g., extend across one of the thermal barriers 204 or compressible layers 206) and/or are coupled via one of the bus bars 222 may protrude out of a frame housing the cell stack 200, as described further below. Pairs of tabs 210 directly welded and not bridging a thermal barrier 204 or compressible layer 206 may not protrude out of the frame. Thus, tabs 210 that bridge and/or are coupled indirectly (e.g., via one of the bus bars 222), such as the second tabs 218, may be longer than tabs 210 that do not bridge and are coupled via direct welds 220, such as the first tabs 216. Additionally or alternatively, tabs 210 coupled via one of the bus bars 222, such as the second tabs 218, may include more bends than tabs 210 coupled via direct welds 220, such as the first tabs 216. As an example, tabs 210 coupled via one of the bus bars 222, such as the second tabs 218, may include three bends, while tabs 210 coupled via direct welds 220, such as the first tabs 216, may include two bends. Additionally or alternatively, tabs 210 coupled via one of the bus bars 222, such as the second tabs 218, may include an odd number of bends, while tabs 210 coupled via direct welds 220, such as the first tabs 216, may include an even number of bends. Additionally or alternatively, tabs 210 coupled via one of the bus bars 222, such as the second tabs 218, may be parallel with the x-axis where welded to the bus bars 222, while tabs 210 coupled via direct welds 220, such as the first tabs 216, may be parallel with the y-axis where welded directly together. Different shapes of the tabs 210 than shown in FIG. 2 are possible without departing from the scope of the present disclosure.

Tabs 210 that are coupled via bus bars 222 and/or that bridge one of the thermal barriers or compressible layers 206 may protrude out of the frame housing the cell stack 200 to allow access by a welder (e.g., person or automated machine) to weld the tabs post-assembly (e.g., after assembling the cell stack within the frame). By decreasing the number of tabs 210 coupled via bus bars 222, the number of tabs 210 protruding out of the frame may be reduced. In this way, at least some of the tabs 210 may be directly welded prior to inserting the cells into the frame, decreasing a number of post-assembly bending and welding operations as described with regard to the method of FIG. 7 below. Further, decreasing the number of bus bars may reduce parts and thus resource demand for producing a battery pack in accordance with the present disclosure. Further still, reducing bus bars may minimize the packing volume of the battery stack and allow for increased ventilation.

In the example cell stack 200, half of the tabs 210 (e.g., the first tabs 216) are directly welded (e.g., welded to each other without a bus bar) and the other half of the tabs 210 (e.g., the second tabs 218) are indirectly welded (e.g., welded to corresponding bus bars), as described above. In another example, more than half of the tabs 210 may be coupled directly. For instance, all of the tabs 210 may be directly welded, rather than coupled via a bus bar.

Turning to FIG. 3A, a battery pack 350 comprising another example of a cell stack 300 is schematically illustrated, where the cell stack 300 does not include bus bars, such as the bus bars 222 of FIG. 2 for coupling the tabs 210 of the cells 202. The cell stack 300 may include the cells 202, the thermal barriers 204, and the compressible layers 206, with different tab 210 configurations than the cell stack 200 of FIG. 2. The cell stack 300 may achieve similar benefits as described with regard to the cell stack 200 above, including reducing parts, resource demand, packing volume, and manufacturing complexity, due to directly welding the corresponding adjacent tabs 210 together. A choice between utilizing a combination of bus bars and direct welds or only direct welds for coupling the tabs 210 (e.g., such as in cell stack 200 or 300, respectively) may depend on desired venting configurations for thermal control, as described further below in regard to FIG. 4.

The cell stack 300 may be physically supported by a frame 302 of the battery pack 350. In one example, the frame 302 may be integral with the thermal barriers 204. In this way, the frame 302 may be shaped similar to a ladder. For example, the thermal barriers 204 may extend between walls of the frame 302 positioned at the first side 212 and the second side 214, similar to rungs of a ladder extending between rails. In another example, the thermal barriers 204 may be separate from the frame 302. For example, the thermal barriers 204 may be permanently or separably coupled to the frame 302. Separably coupled components may be removed from one another and recoupled repeatedly without causing degradation to the components.

The frame 302 may partially surround the cell stack 300. For example, the pairs of the cells 202 may each be surrounded on at least two sides by the frame 302. In this way, at least one side of the frame 302 may be open, exposing the cell stack 300 as described further below. Additionally, the frame 302 may include venting windows on one or more sides, such as shown in FIG. 4 and described further below.

The cells 202, the thermal barriers 204, and the compressible layers 206 may be arranged in a repeating pattern. For example, the pattern may be the same as the pattern within the cell stack 200 described above with regard to FIG. 2 such that the cells 202 are grouped into pairs with alternating compressible layer 206 or thermal barrier 204 between each cell pair. In other examples, the cells 202, the compressible layers 206, and the thermal barriers 204 may be arranged (e.g., ordered) differently. Additionally or alternatively, there may be different relative numbers of the cells 202, the compressible layers 206, and the thermal barriers 204.

Like the cell stack 200 of FIG. 2, the cells 202 may be coupled in series. There may not be any cells 202 connected in parallel. For example, as described above, the first first tab 216a may be coupled to the second first tab 216b adjacent and to the left of the first first tab 216a. The first second tab 218a may be coupled to the second second tab 218b adjacent and to the right of the first second tab 218a, and so on. Thus, the orientations of the cells 202 may alternate throughout the cell stack between cathode tab on the first side 212 and anode tab on the first side 212.

The first tabs 216 at the first side 212 may be directly welded to each other as described above with regard to the cell stack 200 of FIG. 2. Additionally, the second tabs 218 at the second side 214 may also be directly welded to each other, rather than coupled via welding to a bus bar such as the bus bars 222 of FIG. 2. Thus, tabs 210 which protrude from the frame 302 due to bridging the thermal barriers 204 and compressible layers 206, such as the second tabs 218, may be directly welded in some examples. In this way, the cell stack 300 may be absent of bus bars. That is, all of the tabs 210 may be directly welded to each other, without bus bars.

The second tabs 218 may be bent differently in the cell stack 300 than the cell stack 200 of FIG. 2. Specifically, in the cell stack 300, the second tabs 218 may be bent such that the second tabs 218 are adapted to be directly welded to each other, whereas in the cell stack 200 of FIG. 2, the second tabs 218 may be bent such that the second tabs 218 are adapted to couple via welding to a bus bar.

Further, various tab bend configurations may be possible for directly welded tabs. For example, turning to FIG. 3B, the battery pack 350 is shown where the tabs 210 are bent such that the direct welds 220 are positioned on surfaces of the tabs 210 parallel with the y-axis, rather than the x-axis as shown in FIG. 3A. The tabs 210 each include two bends (e.g., two corners) in FIG. 3B, as opposed to a single bend each in FIG. 3A. A combination of differently bent tabs is also possible in examples where all of the tabs 210 are directly welded to each other. For example, the first tabs 216 may be bent as shown in FIG. 3A, and the second tabs 218 may be bent as shown in FIG. 3B. Such a configuration as shown in FIG. 3B may be less space efficient than as shown in FIG. 3A as the tabs 210 protrude further from the cells 202. Additionally, the configuration shown in FIG. 3B may demand additional manufacturing steps due to each tab including two bends rather than one. Thus, although many tab bend configurations are possible without departing from the scope of the present disclosure (including configurations not shown such as curved tabs or tabs having three or more bends), a tab bend configuration including one bend in each tab (e.g., resembling FIG. 3A) may be desired to reduce manufacturing steps and packing volume.

The frame 302 may comprise a plurality of interconnected frame subunits, in one example. Each frame subunit may house a portion of the cell stack 300.

Turning to FIG. 4, an example of a frame subunit 400 is shown. The frame subunit 400 may be a subunit of the frame 302 of FIGS. 3A and 3B. For example, the frame subunit 400 may house a portion of a cell stack, such as the cell stack 300 of FIGS. 3A and 3B or the cell stack 200 of FIG. 2. The portion of a cell stack (e.g., cell stack 200 or cell stack 300) housed by a single frame piece (e.g., frame subunit 400) may be referred to herein as a cell packet. In examples where the frame is a single integral piece (e.g., one unit rather than a plurality of subunits), the cell packet may include the entire cell stack. The cell packet may include one or more cells (e.g., cells 202), one or more compressible layers (e.g., compressible layer 206), and in some examples, additional or alternative layers. In at least some examples, the frame subunits 400 of a frame may be identical to one another. Accordingly, the cell packets of a battery pack in accordance with the present disclosure may be identical to one another, each cell packet housed within one of the identical frame subunits. An example of a cell packet is described further below in regard to FIG. 5.

The frame subunit 400 may have a first side 412, a second side 414, a first end 432, and a second end 434. The first side 412 and the second side 414 may be opposite along the y-axis. That is, features described as being at or near the second side 414 may be in a relatively negative y-direction from features described as being at or near the first side 412. Additionally or alternatively, the first end 432 and the second end 434 may be opposite along the x-axis. Therefore, features described as being at or near the second end 434 may be in a relatively positive x-direction from features described as being at or near the first end 432. A plurality of the frame subunit 400 may be arranged end-to-end (e.g., first end 432 of a first frame subunit against second end 434 of a second frame subunit, first end 432 of the second frame subunit against and parallel with second end 434 of a third frame subunit, and so on) to form a frame (e.g., frame 302 of FIGS. 3A and 3B) of a battery pack in accordance with the present disclosure, as described below with regard to FIG. 6.

The frame subunit 400 may include one or more walls, such as one or more of a first wall 402, a second wall 404, and a third wall 406, and one or more posts 408. The one or more walls may be oriented perpendicular to one another. For example, the first wall 402 may be arranged perpendicular (e.g., normal) to the second wall 404 and the third wall 406. The second wall 404 and the third wall 406 may extend along the perimeter of the first wall 402. In this way, the frame subunit 400 may partially surround a space 436 adapted to receive a cell packet. The space 436 may be defined by the walls (e.g., the first wall 402, the second wall 404, the third wall 406) and the posts 408 of the frame subunit 400. The space 436 may be located on the side of the first wall 402 closest to the second end 434.

The first wall 402, the second wall 404, and the third wall 406 may be rectangular in one example. In this way, the frame subunit 400 may be rectangular prism shaped. In other examples, the first wall 402, the second wall 404, and the third wall 406 may be shaped according to cells that are adapted to be housed therein, such as the cells 202 of FIGS. 2-3B. Further, the dimensions of the frame subunit 400, including a length 422, a width 424, and a depth 426, may be selected according to dimensions of a cell packet adapted to be housed within the frame subunit 400, as described further below. As used herein, a length may be a dimension of the referenced component parallel with the y-axis, a width may be a dimension of the referenced component parallel with the z-axis, and a depth may be a dimension of the referenced component parallel with the x-axis.

Additionally, the frame subunit 400 may be open on at least one side. That is, at least one side of the frame subunit 400 may not include a wall. For example, a rectangular prism shaped frame subunit may include five or fewer walls such that one or more sides do not include a wall. In the example shown in FIG. 4, the frame subunit 400 is open on three sides. As another example, a triangular prism shaped frame subunit (e.g., where the first wall is triangular and there are three posts) may include four or fewer walls such that one or more sides do not include a wall. The frame subunit 400 may also be other shapes in other examples, such as other polygonal shapes or rounded (e.g., circular, oval, organic/asymmetric rounded shape, etc.). For example, the first wall 402 may be circular and a curved wall may extend partially along the perimeter thereof, leaving an opening along the rest of the perimeter.

One or more of the walls may include one or more venting windows, such as venting window 416 of the third wall 406. The venting windows may allow air circulation through the battery pack for thermal management thereof. The third wall 406 may further include one or more tab openings 418 adapted to receive tabs of the cells positioned within the frame subunit 400. The venting window 416 and the tab openings 418 may be shaped differently from one another. For example, the tab openings 418 may be elongated slits shaped and sized to permit the tabs to extend therethrough. The venting window 416 may be sized and shaped to maximize air flow therethrough. The venting window 416 and tab openings 418 may be positioned according to the cell packet adapted to be positioned in the frame subunit 400. For example, the venting window 416 may be proximate to tabs of the cell packet that are directly welded to each other such as the first tabs 216 of FIGS. 2-3B. In addition to the venting window 416, leaving two or more sides open (e.g., leaving negative space between adjacent posts 408) as described above may provide further venting pathways. For example, a venting window may be formed from a space 438 (e.g., vertical space in the orientation shown in FIG. 4) between a first post 408a and a second post 408b at the second side 414 when the frame subunit 400 is interconnected with other identical frame subunits. Other configurations of venting windows than shown in FIG. 4 are possible without departing from the scope of the present disclosure, such as including additional or alternative venting windows with other shapes, placement, and/or proportions according to the cell packet configuration (e.g., tab configuration). For example, venting windows may be positioned differently for frame subunits housing a cell packet of the cell stack 200 of FIG. 2 and a cell packet of the cell stack 300 of FIGS. 3A and 3B. Likewise, the frame subunit 400 may include further tab openings, such as shown in FIG. 10 and described below.

The posts 408 may extend from the first wall 402. Specifically, the posts 408 may extend from corners of the first wall 402. For examples where the first wall 402 is rectangular, there may be four posts 408, one positioned at each corner of the first wall 402. The second wall 404 may extend along a perimeter of the first wall 402 between two posts 408. Likewise, the third wall 406 may extend along the perimeter of the first wall 402 between two posts 408. In some examples, the second and third walls 404, 406 may intersect. For example, the two posts wherebetween the second wall 404 extends may include one of the two posts wherebetween the third wall 406 extends. There may be additional posts in other examples, such as examples with different wall geometry and/or demand for additional support. For example, one or more posts may extend from edges of the perimeter of the first wall 402, in addition or alternative to the corners of the perimeter. The posts 408 may all be parallel to each other in at least some examples.

The posts 408 may be adapted to couple with posts of another frame, which may be identical to the frame subunit 400. For example, the posts 408 may each include an opening 430 at one end thereof and a protrusion 428 at the other end thereof. The protrusion 428 of a first post of a first frame may be received by the opening 430 of a second post of a second frame. In this way, the posts 408 may be connected collinearly such that the frame subunits 400 are aligned in series in a stack to form a frame such as the frame 302 of FIGS. 3A and 3B. The frame subunits 400 may interconnect in that way to form a ladder shaped frame, in one example.

In some examples, all of the posts 408 may be oriented the same relative to the walls. Specifically, the posts 408 may all protrude in a common direction (e.g., in the same direction). For example, the posts 408 are shown in FIG. 4 at the second end 434 relative to the first wall 402 with the openings 430 open to the second end 434 and the protrusions 428 extending from the first wall 402 at the first end 432. In this way, the posts 408 may all be located mostly on the second end 434 with the protrusions 428 extending toward the first end 432. In other examples, the posts 408 may not all protrude in the same orientation. For example, one or more of the posts 408 may extend towards the second end 434 from the first wall 402 and one or more of the other posts 408 may extend towards the first end 432 from the first wall 402. As an example, the frame subunit 400 is further shown in FIG. 5 with four posts 408 where one of the posts 408 is on an opposite side of the first wall 402 from the other three of the posts 408. Additionally or alternatively, some of the openings 430 may be open towards the first end 432 while others open towards the second end 434. Accordingly, the protrusions 428 that belong to the same posts 408 as the openings 430 that are open towards the first end 432 may extend towards the second end 434, while the protrusions 428 that belong to the same posts 408 as the openings 430 that are open to the second end 434 may extend towards the first end 432. In this way, the opening 430 of one of the posts 408 may be opposite the protrusion 428 of the same post 408. That is, the opening 430 and the protrusion 428 of the same post 408 may be nearer opposite ends (e.g., the first end 432 and the second end 434, respectively or vice versa). However, not all protrusions 428 may be on the same end of the first wall 402 as each other, and not all openings may be on the same side of the first wall 402 as each other. In other words, some posts 408 may be oriented oppositely from others of the posts 408.

Turning to FIG. 5, a subassembly 500 comprising the frame subunit 400 with a cell packet 502 housed therein is shown. A battery pack in accordance with the present disclosure may comprise a plurality of the subassembly 500, for example as shown in FIG. 6.

The cell packet 502 may comprise two pairs of cells 202 with a compressible layer 206 interposed between the two pairs, as an example. The tabs (e.g., tabs 210 of FIGS. 2-3B) of the cells 202 are not shown in FIGS. 5 or 6 for generalization to include various cell tab configurations. For example, the cell packet 502 may be a portion of the cell stack 200 or the cell stack 300, where configurations of the cell tabs 210 differ between the cell stack 200 and the cell stack 300. At least some of the tabs of the cell packet 502 may be welded directly to each other prior to assembly with (e.g., insertion within) the frame subunit 400, as described further with reference to the method of FIG. 7. In this way, battery pack 600 of FIG. 6 may include either the cell stack 200 or the cell stack 300. A more specific example is shown in FIGS. 8-11 and described below of the battery pack where all of the tabs are directly welded to each other similar to the cell stack 300.

The cell packet 502 may be positioned within the space 436 partially enclosed by the one or more walls and posts of the frame subunit 400. The length 422 may be greater than a cell packet length 522, the width 424 may be greater than a cell packet width 524, and the depth 426 may be greater than a cell packet depth 526 such that the cell packet 502 fits within the space 436. Thus, the posts 408 may be arranged around a perimeter of the cell packet 502. The second wall 404 and the third wall 406 may surround a portion (e.g., half) of the perimeter of the cell packet 502. The cells 202 may be positioned parallel with the first wall 402. For example, the stacking axis wherealong the cells 202 and the compressible layer 206 are stacked may be perpendicular to the first wall 402. The cell packet 502 may be oriented relative to the frame subunit 400 with the first side 212 at the first side 412 (e.g., proximate to the first side 412 relative to the other sides of the frame subunit 400), the second side 214 at the second side 414 (e.g., proximate to the second side 414 relative to the other sides of the frame subunit 400), the first end 232 at the first end 432 (e.g., proximate to the first end 432 relative to the other ends of the frame subunit 400), and the second end 234 at the second end 434 (e.g., proximate to the second end 434 relative to the other ends of the frame subunit 400).

The cell packet 502 may be spaced away from some of the walls and posts of the frame subunit 400. That is, the cell packet 502 may fit within the space 436 without physically contacting the posts 408 positioned around the space 436. However, the cell packet 502 may be compressed in between and in face-sharing contact with the first walls 402 when the subassemblies 500 are stacked to form a battery pack as described further below.

The frame subunit 400 may be integral with the thermal barriers of the cell stack, as noted above. For example, the first wall 402 may be the thermal barrier 204 of FIGS. 2-3B. The cell packet 502 may be oriented within the frame subunit 400 such that the tabs of the cells 202 that cross thermal barriers or compressible layers (e.g., second tabs 218 of FIGS. 2-3B) extend through the tab openings 418, as described further below in regard to FIG. 10.

Turning to FIG. 6, a battery pack 600 comprising several of the subassembly 500 is shown. The subassemblies 500 may be stacked along the x-direction. Specifically, the subassemblies 500 may be stacked end-to-end (e.g., first end 432 of a first frame next to second end 434 of the adjacent frame). Stacking the subassemblies 500 may form a cell stack 602 comprising the cell packets 502 and a frame 604 comprising the frame subunits 400. The cell stack 602 may further include the first walls 402 which may function as thermal barriers (e.g., thermal barriers 204 of FIGS. 2-3B) interposed between the cell packets 502. The cell stack 602 may be the cell stack 200 or 300 of FIGS. 2-3B, respectively, as an example. The frame 604 may be an example of the frame 302 of FIGS. 3A and 3B. The second side 214 of the cell packets 502 is visible in the view shown in FIG. 6 through the spaces 438 between the first walls 402 on the second side 414 of the frame subunits 400. Additionally, there may be an exposed cell packet 502a on one end of the battery pack 600, where the exposed cell packet 502a is not interposed between two of the first walls 402. Rather, a cell of the cell packet 502a may be exposed to the outside of the frame 604 (e.g., on one more side than the other cells in the cell stack 602).

The second walls 404 may be aligned such as to be flush and coplanar, forming a continuous surface at a top 606 of the battery pack 600. Similarly, the third walls 406 may be aligned such as to be flush and coplanar, forming a continuous surface at the side 412. The spaces 438 may be aligned such as to be coplanar and separated by the first walls 402, forming a discontinuous surface at the second side 414. The spaces 438 may be configured as venting windows, opposite the venting window 416 on the first side 412. Likewise, spaces may align such as to be coplanar and separated by the first walls 402 at a bottom 608 of the battery pack 600. In this way, the frame 604 may be ladder shaped.

The subassemblies 500 may interconnect with each other. Specifically, the posts 408 may interconnect via the openings 430 receiving the neighboring protrusions 428. In this way, alignment of the subassemblies 500 may be maintained by the interaction of the openings 430 and the protrusions 428. Other means of connecting the subassemblies are also possible without departing from the scope of the present disclosure. Further, in other examples, the frame may be a different shape. Additionally or alternatively, the frame may be a single integral piece.

The tabs of the cells 202 (e.g., tabs 210 of FIGS. 2-3B) may protrude out of the frame 604 on the second side 414. Specifically, the tabs may extend out of the frame 604 via the tab openings 418. The protruding tabs on the second side 214 may be coupled via corresponding bus bars, direct welds, or a combination thereof. For example, all tabs on the second side 214 (e.g., second tabs 218 of FIGS. 2-3B) may be welded to a corresponding bus bar (e.g., bus bar 222 of FIG. 2) positioned outside of the frame 604. Alternatively, all tabs on the second side 214 (e.g., second tabs 218 of FIGS. 2-3B) may be welded directly to each other in pairs with the direct weld location positioned outside of the frame 604. Alternatively, some of the tabs on the second side 214 (e.g., second tabs 218 of FIGS. 2-3B) may be welded directly and others may be welded to bus bars. For example, tabs bridging thermal barriers and tabs bridging compressible layers may be welded directly and indirectly, respectively or vice versa, such that there is an alternating pattern of bus bars and direct welds along the second side 214.

Due to being directly welded and not bridging thermal barriers or foam layers, the tabs of the cells 202 on the first side 212 (e.g., first tabs 216 of FIGS. 2-3B) may not protrude out of the frame 604. In this way, a packing volume of the battery pack 600 may be reduced compared to examples where all of the cell tabs protrude from the frame and/or are coupled via bus bars. Further, post-assembly bending and welding on the first side 212 may be eliminated, thereby simplifying manufacturing processes as described below with regard to FIG. 7.

Turning to FIGS. 8-11, an example 800 of the battery pack 600 is shown including a cell stack 802 where, similar to the cell stack 300 of FIGS. 3A and 3B, the tabs 210 are all directly welded to each other. To elaborate, the tabs 210 are coupled to each other via direct welds 220 only, as opposed to via bus bars (e.g., bus bars 222 of FIG. 2) additionally or alternatively to the direct welds 220. In this way, in the example 800, there are not any bus bars coupling the tabs 210.

FIG. 9 shows the first side 412 of the frame 604, where the first side 212 of the cell stack 602 is visible through the spaces 438. Specifically, the first tabs 216 are shown grouped in pairs which are physically and electrically coupled to each other via the direct welds 220. For example, the first first tab 216a is directly welded to the second first tab 216b, as described above. In this way, one or more bus bars used in previous examples to couple the tabs 210 which do not bridge the thermal barriers 204 or the compressible layers 206 (e.g., pairs of the first tabs 216) may be eliminated, reducing size and complexity of the battery pack.

FIG. 10 shows the second side 414 of the frame 604 and the second side 214 of the cell stack 602 where the second tabs 218 bridge the thermal barriers 204 and the compressible layers 206.

The tab openings 418 may be sized to permit the tabs 210 to extend therethrough. For example, the tab openings 418 may be elongated slits with dimensions greater than parallel dimensions of the tabs 210 (e.g., a height 1010 of the tab openings 418 being greater than a height 1014 of the tabs 210). In this way, one of the tabs 210 may extend through each of the tab openings 418. For example, the first second tab 218a may extend through a first tab opening 418a, the second second tab 218b may extend through a second tab opening 418b, the third second tab 218c may extend through a third tab opening 418c, and the fourth second tab 218d may extend through a fourth tab opening 418d. Thus, the tabs 210 may extend from the cells 202 within the frame 604 to outside of the frame 604 via the tab openings 418. The tab openings 418 may be spaced away from the edges of the frame 604 and from the venting windows 416. Alternatively, the tab openings 418 may intersect the venting window 416 to form one larger continuous opening wherethrough the tabs 210 extend and air flow is permitted for thermal management of the cells 202.

The tab openings 418 may be unevenly spaced away from each other. More specifically, tab openings 418 of the same frame subunit 400 may be arranged closer together compared to adjacent tab openings 418 of a neighboring frame subunit 400. As an example, a first tab opening distance 1002 between adjacent tabs openings 418 of different frame subunits 400 such as the first tab opening 418a and the second tab opening 418b may be greater than a second tab opening distance 1004 between adjacent tab openings 418 of the same frame subunit 400, such as the third tab opening 418c and the fourth tab opening 418d. For example, the first tab opening distance 1002 may be twice the second tab opening distance 1004.

Consequently, the pairs of the tabs 210 which are directly welded to each other may overlap by different amounts. For example, the first and second second tabs 418a, 418b may overlap by a first overlap distance 1006. Likewise, the third and fourth second tabs 418c, 418d may overlap by a second overlap distance 1008. The first and second overlap distances 1006, 1008 may be up to a width 1016 of the tabs 210. The tabs 210 may be in face-sharing contact with each other at the corresponding areas of overlap. Further, the tabs 210 may be physically and electrically coupled via the direct welds 220 at the areas of overlap. The second tabs 218 may be bent flush against the walls 406 of the frame 604. In this way, the second tabs 218 which extend through the tab openings 418 may retain the cells relative to the walls 406. Due to the first tab opening distance 1002 being larger than the second tab opening distance 1004, the first overlap distance 1006 may be smaller than the second overlap distance 1008 if the tabs 210 are identically shaped. Alternatively, the tab openings 418 may be equidistantly spaced such that the overlap distances are approximately equal for each tab pair.

The tabs 210 are shown as thin rectangular shapes bent at approximately 90 degree angles and extending partially along the vertical height of the cells 202 (e.g., dimension parallel with the z-axis). However, the tabs 210 may take other shapes, such as triangular, curved, etc., and may be bent at different angles than 90 degrees with sharp or rounded edges along the bends. Any shape of the tabs 210 that allows direct welding of the corresponding tabs along sufficiently large welding surface areas (e.g., areas where the tabs 210 are in face-sharing contact with each other) is possible. The tab openings 418 may be shaped accordingly to receive the tabs 210.

Further, the tabs 210 may be shaped and/or bent differently from each other. For example, the tabs 210 may be bent differently from each other according to whether the tabs 210 protrude out of the frame 604. In this way, the first tabs 216, which may not protrude from the frame 604 as described above, may be bent differently than the second tabs 218, which may protrude from the frame 604 through the tab openings 418. As an example, the first tabs 216 may include a bend closer to the cells 202 such that the first tabs 216 extend by a smaller distance from the cells 202 compared to the second tabs 218. Additionally or alternatively, the tabs 210 that bridge thermal barriers (e.g., first and second second tabs 218a, 218b) may be shaped differently than tabs 210 that bridge compressible layers (e.g., third and fourth second tabs 218c, 218d) and tabs that do not bridge the thermal barriers or compressible layers (e.g., first tabs 216).

FIG. 11 shows a single subassembly of the example 800, including the frame subunit 400 and the cell packet 502. In the example 800, the cell packet 502 includes a different arrangement of cells 202 and compressible layers 206 compared to the example of FIG. 5. For example, in FIGS. 8-10, the cell packets 502 are shown with additional compressible layers 206 interposed between the cells 202 and the thermal barriers 204 (e.g., the first walls 402), such as a first compressible layer 206a. In this way, the cell pairs may each be interposed between and in face-sharing contact with two of the compressible layers 206. However, in some examples, some of the cells 202 may be directly in face-sharing contact with the thermal barriers 204 as shown in FIG. 5. Thus, the number and/or arrangement of the compressible layers 206 may vary between examples.

Turning to FIG. 7, a flowchart of a method 700 is shown for manufacturing a battery pack in accordance with the present disclosure. The resulting battery pack may include at least some cell tabs welded directly to each other rather than via a bus bar. In this way, there may be fewer bus bars in the battery pack than one less than half the number of cell tabs.

The method 700 begins at 702, wherein cells having tabs are stacked into one or more cell pairs. Each cell pair may include two cells (e.g., cells 202 of FIGS. 2-3B, 5, 6, and 8-11). The cells each include two or more tabs (e.g., tabs 210 of FIGS. 2-3B, and 8-11), such as an anode tab and a cathode tab. The tabs may extend in opposing directions, in at least some examples. Each cell packet may further include one or more compressible layers (e.g., compressible layer 206 of FIGS. 2-3B, 5, 6 and 8-11).

The method 700 may include 704, wherein a first portion of the tabs are bent. Bending the tabs may configure at least some of the tabs to be welded directly to each other. Bending the first portion of the tabs may occur prior to 702 in another example. In examples where some of the tabs are configured to be welded via bus bars, those tabs may be bent at later points in the method 700, such as post-assembly. Thus, tabs welded directly (e.g., without a bus bar) and indirectly (e.g., with a bus bar) may be bent at different points in the method 700 (e.g., at 704 and 714, respectively). Additionally or alternatively, tabs configured to bridge non-cell layers and tabs that do not bridge non-cell layers may be bent at different points in the method 700 (e.g., at 714 and 704, respectively). Additionally or alternatively, tabs configured to extend through tab openings in a frame housing the cells (e.g., second tabs 218 extending through the tab openings 418 as shown in FIG. 10) and tabs configured to be contained within the frame (e.g., first tabs 216 as shown in FIGS. 9 and 11) may be bent at different points in the method 700 (e.g., at 714 and 704, respectively). In examples where the method 700 does not include 704, the first portion of tabs may be pre-bent (e.g., bent prior to starting the method 700) or otherwise pre-configured to be welded directly to adjacent tabs.

The method 700 proceeds to 706, wherein the first portion of the tabs are pre-assembly welded directly to each other. Specifically, during pre-assembly welding, tabs of a cell packet may be welded directly to other tabs of the same cell packet. For example, pre-assembly welding may include a tab of each of the cells being directly welded to an adjacent tab of the corresponding cell pair, similar to the first tabs 216 of FIGS. 2-3B, 8, 9 and 11. For examples where the cell packet comprises a first cell pair, a second cell pair, and a compressible layer interposed therebetween, a first tab of a first cell of the first cell pair may be directly welded to a second tab of a second cell of the first cell pair, and a third tab of a third cell of the second cell pair may be directly welded to a fourth tab of a fourth cell of the second cell pair. That is, the first portion of tabs may include the first, second, third, and fourth tabs. The first, second, third, and fourth tabs may be oriented on the same side of the cell packet (e.g., first side 212 of FIGS. 2-3B, 8, 9, and 11), in at least some examples. The remaining tabs (e.g., tabs not included in the first portion), such as tabs on the opposite side across the cells and configured to bridge a thermal barrier or a compressible layer may not be welded directly to each other during pre-assembly welding. For example, the first, second, third, and fourth cells may be stacked in that order with the compressible layer between the second and third cells such that the first cell and the fourth cell may be outer cells and the second and third cells may be inner cells. Outer cells may be positioned at ends of the cell packet and not in face-sharing contact with the compressible layer, and the inner cells may be positioned in between the outer cells and in face-sharing contact with the compressible layer. Pre-assembly welding may not include welding a fifth tab and a sixth tab of the inner cells together. Additionally, pre-assembly welding may not include welding a seventh tab and an eighth tab of the outer cells to other cells outside of the corresponding cell packet. Thus, pre-assembly welding tabs at 706 may include tabs within a corresponding cell pair being welded directly together without bridging compressible layers or thermal barriers. Pre-assembly welding the tabs may reduce post-assembly bending and welding operations, decreasing manufacturing complexity. In some examples, pre-assembly welding at 704 may occur prior to stacking at 702. That is, pre-assembly welding may occur before or after stacking.

The method 700 proceeds to 708, wherein the cell pairs are assembled with a frame (e.g., frame 604 of FIG. 6). One or more cell packets each comprising at least one of the cell pairs may be stacked together to form a cell stack of the battery pack, such as the cell stack 200 of FIG. 2, the cell stack 300 of FIGS. 3A and 3B, the cell stack 602 of FIG. 6, or the cell stack 802 of FIGS. 8-10. As an example, the cell packets may each include two pairs of cells and a compressible layer interposed between the two pairs (e.g., two cells on both sides of the compressible layer). In this way, the cell packet may be symmetrically stacked. In other examples, the cell packet may comprise different (e.g., additional or alterative) components and/or may be asymmetrically stacked (e.g., different numbers of cells on both sides of the compressible layer). The frame may be adapted to house and support the cell stack. Assembling the cell pairs with the frame may include inserting the cells into the frame. Assembling the cell pairs with the frame may further include inserting some of the tabs into tab openings, such as the tab openings 418. For example, tabs not yet bent at this point in the method 700 may be pushed through the tab openings. Assembling the cell pairs with the frame may further include compressing the compressible layers, thereby providing compression force to the cells for increased durability and lifespan. The frame may be integral with components of the cell stack, such as the thermal barriers, in at least some examples. The frame may be a single integral piece in some examples. In other examples, the frame may include a plurality of frame subunits, such as the frame subunit 400 of FIGS. 4-6 and 8-11.

Hence, assembling the cell packets with the frame at 708 may include 710, wherein two or more subassemblies are assembled, each subassembly including a frame subunit housing one of the one or more cell packets which each includes at least one cell pair. The frame subunit may house a single cell packet comprising four cells and a compressible layer as shown in FIG. 5. However, the cell packet may include additional layers in other examples. For example, referencing FIG. 4, the depth 426 of the frame subunit 400 may be increased to accommodate larger cell packets comprising more than four cells and/or more than one compressible layer. In one example, there may be compressible layers added to both ends of the cell packets as shown in FIGS. 8-11. Assembling the cell packets with the frame may include inserting each cell packet into a space (e.g., space 436 of FIGS. 4 and 5) partially surrounded by the frame subunit such that the cell packet is housed by the frame subunit. Further, some of the tabs may protrude through the frame, for example via tab openings such as the tab openings 418 of FIGS. 4, 6 and 10.

Additionally, assembling the cell packets with the frame at 708 may include 712, wherein the frame subunits of the subassemblies are interconnected. Specifically, the frame subunits may be fastened together with corresponding walls parallel and/or coplanar with each other. For example, referencing FIG. 4, when a plurality of the frame subunits 400 are interconnected, the first walls 402 may be parallel to each other, the second walls 404 may be coplanar with each other, and the third walls 406 may be coplanar with each other. Further, the walls coplanar with each other may be flush with each other, without gaps therebetween. As an example, posts may fit with adjacent posts to maintain such alignment. More specifically, the protrusions 428 may be inserted into the corresponding openings 430 such that the posts 408 form continuous lines down the frame 604 as shown in FIGS. 6 and 8-10. The posts may be configured in various orientations to allow such interconnection, as described above. Further, other fastening methods for interconnecting the frame subunits are possible without departing from the scope of the present disclosure, including but not limited to use of adhesive, other snap-fit or press-fit configurations, etc.

In examples where the frame is a single integral piece, assembling the cell pairs with the frame at 708 may not include 710 and 712. In such an example, the cell pairs may be slid into the corresponding spaces from sides of the frame. For example, rather than sliding the cell pairs in a direction parallel with the stacking axis wherealong the cells are stacked within the cell stack, the cell pairs may slide perpendicular to the stacking axis. In this way, the cell packet may slide between two posts rather than four, with the side comprising the welded first portion of tabs being inserted first. However, constructing the frame from frame subunits may be advantageous due to allowing for easier positioning of the cell packets in the correct placement, such as in alignment with the frame. Further, producing the frame subunits may be simpler than a single integral frame piece due to geometry of the frame (e.g., ladder shape).

When the cell packets are assembled with the frame, the first portion of tabs which were pre-assembly welded at 706 may not protrude from the frame. That is, the first portion of tabs may be enclosed by the frame. Tabs not included in the first portion may protrude from the frame (e.g., via tab openings) such that those tabs are prepared to bridge the compressible layers and thermal barriers.

Following assembly, the method 700 proceeds to 714, wherein remaining unwelded tabs are bent. The remaining unwelded tabs may include tabs not pre-assembly welded to each other. That is, the remaining unwelded tabs may be a second portion of tabs comprising different tabs than the first portion. The remaining unwelded tabs may be configured to bridge non-cell layers (e.g., the compressible layers, thermal barriers, and the like) to couple cells of different cell groups (e.g., pairs) on opposite sides of the non-cell layers, such as the second tabs 218 of FIGS. 2-3B, and 10. The remaining unwelded tabs may be tabs on an opposite side from the first group of tabs. Tabs configured to be directly welded (e.g., tabs bent at 704, if included) and tabs configured to be welded to a bus bar (if any) may include different geometry, such as different bend angles, bend placement, and/or different numbers of bends, as described above with regard to FIG. 2. Additionally or alternatively, tabs configured to bridge and not bridge non-cell layers may include different geometry. As an example, bends of tabs which protrude from the frame may be located further from the cells to accommodate the frame interposed between the cell and the bend in the tab. Therefore, bending at 704, if included, may result in different tab geometry than bending at 714.

The method 700 proceeds to 716, wherein the remaining unwelded tabs are post-assembly welded. Post-assembly welding at 716 may include 718, wherein the remaining unwelded tabs are welded to corresponding bus bars. As an example, manufacturing a battery pack comprising the cell stack 200 of FIG. 2 may include 718, due to the second tabs 218, which bridge non-cell layers (e.g., thermal barriers and compressible layers), being coupled via welding to bus bars 222. In such an example, the bus bars may be located outside of the frame.

Additionally or alternatively to 718, post-assembly welding at 716 may include 720, wherein remaining unwelded tabs are welded directly to each other. As an example, manufacturing a battery pack comprising the cell stack 300 of FIGS. 3A and 3B or the example 800 of FIGS. 8-11 may include 720 but not 718, as all of the tabs including the first tabs 216 and the second tabs 218, which respectively are prevented from bridging and do bridge non-cell layers, are directly welded. In another example, some of the tabs which bridge the non-cell layers may be directly welded and others may be welded to bus bars. Thus, the method 700 may include 718 and/or 720, in either order when both included. For example, 718 may occur before 720 as shown, or 718 may occur following 720, when both steps are included.

Post-assembly welding at 718 and/or 720 may occur following assembling at 708 such that the cell stack is positioned within the frame during welding at 718 and/or 720. Conversely, the cells may not be within the frame during pre-assembly welding at 706 which may occur prior to assembling at 708. Reducing the number of bending and welding operations occurring post-assembly (e.g., after assembling at 708) by including 706 may decrease manufacturing complexity.

The method 700 ends after 714. Executing the method 700 may result in a battery pack in accordance with the present disclosure where at least some of the cell tabs are directly welded rather than via a bus bar. For examples where the method 700 does not include 718, all of the tabs may be directly welded, such as in the cell stack 300 of FIGS. 3A and 3B and the cell stack 802 of FIGS. 8-10. For examples where the method 700 includes 718, some of the tabs may be directly welded and other tabs may be welded to bus bars, such as in the cell stack 200 of FIG. 2.

The technical effect of the battery pack disclosed herein is to reduce bus bars included for coupling cells of the battery pack. At least some of the tabs may be coupled via direct welds rather than via a bus bar. That is, instead of welding two tabs to a corresponding bus bar to couple the tabs, the two tabs may be directly welded to each other. Reducing bus bars may decrease resource demand and manufacturing complexity. For example, fewer parts and therefore fewer welding operations may be demanded to produce the battery pack of the present disclosure than conventional battery packs with a greater number of bus bars. Additionally, by pre-assembly welding tabs within corresponding cell pairs, post-assembly bending and welding operations may be decreased, further reducing manufacturing complexity. Further, packing volume of the battery pack may be condensed due to some of the tabs not protruding from the frame and reduced (e.g., eliminated) bus bars. Further still, venting window areas may be expanded, maximizing air flow through the battery pack for thermal management (e.g., more effective dissipation of heat).

The disclosure also provides support for a battery pack, comprising: a cell stack including: cells grouped in pairs, and thermal barriers and compressible layers interposed between the pairs, where a first tab of each of the cells is directly welded to an adjacent first tab in the corresponding cell pair. In a first example of the system, each of the cells further includes a second tab, and wherein the first tabs are positioned on a first side of the cell stack and the second tabs are positioned on a second side of the cell stack opposite the first side across the cells. In a second example of the system, optionally including the first example, a second tab of each of the cells is directly welded to an adjacent second tab of a different cell pair than the corresponding cell pair, and the second tab and the adjacent second tab bridge one of the compressible layers and thermal barriers. In a third example of the system, optionally including one or both of the first and second examples, a second tab of each of the cells and an adjacent second tab of a different cell pair than the corresponding cell pair are welded to a corresponding bus bar, and the second tab and the adjacent second tab bridge one of the compressible layers and thermal barriers. In a fourth example of the system, optionally including one or more or each of the first through third examples, the cells are arranged in series. In a fifth example of the system, optionally including one or more or each of the first through fourth examples, the battery pack further comprises a frame integral with the thermal barriers. In a sixth example of the system, optionally including one or more or each of the first through fifth examples, the frame includes a plurality of frame subunits each housing a cell packet of the cell stack. In a seventh example of the system, optionally including one or more or each of the first through sixth examples, each cell packet includes two cell pairs and one of the compressible layers interposed between the two cell pairs.

The disclosure also provides support for a method of manufacturing a battery pack, comprising: stacking cells having tabs into one or more cell pairs, pre-assembly welding at least some of the tabs directly to each other, assembling the cell pairs with a frame, and post-assembly welding remaining unwelded tabs. In a first example of the method, post-assembly welding includes welding the remaining unwelded tabs directly to each other. In a second example of the method, optionally including the first example, post-assembly welding includes welding the remaining unwelded tabs to corresponding bus bars. In a third example of the method, optionally including one or both of the first and second examples, assembling the cell pairs with the frame includes: assembling two or more subassemblies, each subassembly comprising a frame subunit housing a cell packet including one or more of the cell pairs, and interconnecting the frame subunits. In a fourth example of the method, optionally including one or more or each of the first through third examples, the cell pairs are arranged in cell packets each including two cell pairs and a compressible layer interposed therebetween.

The disclosure also provides support for a battery pack, comprising: a frame, and a cell stack housed within the frame, the cell stack including: a plurality of cells having first tabs on a first side of the cell stack and second tabs on a second side of the cell stack opposite the first side, wherein the cells are grouped only in pairs, and compressible layers and thermal barriers stacked with the pairs, wherein the first tabs couple cells within corresponding cell pairs and do not protrude from the frame, and the second tabs protrude from the frame and bridge the compressible layers and thermal barriers to couple cells of different cell pairs. In a first example of the system, the first tabs are directly welded to each other without bus bars. In a second example of the system, optionally including the first example, the second tabs are directly welded to each other without bus bars. In a third example of the system, optionally including one or both of the first and second examples, the second tabs are welded to corresponding bus bars. In a fourth example of the system, optionally including one or more or each of the first through third examples, the frame is ladder shaped and comprises a plurality of frame subunits integral with the thermal barriers. In a fifth example of the system, optionally including one or more or each of the first through fourth examples, the frame comprises venting windows and tab openings at the second side. In a sixth example of the system, optionally including one or more or each of the first through fifth examples, each cell pair is interposed between one of the compressible layers and one of the thermal barriers, or between two of the compressible layers.

In another representation, a hybrid vehicle comprises: an engine, an electric motor, and a battery pack including a cell stack including cells grouped in pairs, and thermal barriers and compressible layers interposed between the pairs, where a first tab of each of the cells is directly welded to an adjacent first tab of the corresponding cell pair.

FIGS. 1-6 and 8-11 show example configurations with relative positioning of the various components. FIGS. 2, 4, and 8-11 are shown approximately to scale; though other relative dimensions may be used. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery pack, comprising:
a cell stack including:
cells grouped in pairs; and
thermal barriers and compressible layers interposed between the pairs, where a first tab of each of the cells is directly welded to an adjacent first tab in the corresponding cell pair.

2. The battery pack of claim 1, wherein each of the cells further includes a second tab, and wherein the first tabs are positioned on a first side of the cell stack and the second tabs are positioned on a second side of the cell stack opposite the first side across the cells.

3. The battery pack of claim 1, wherein a second tab of each of the cells is directly welded to an adjacent second tab of a different cell pair than the corresponding cell pair, and the second tab and the adjacent second tab bridge one of the compressible layers and thermal barriers.

4. The battery pack of claim 1, wherein a second tab of each of the cells and an adjacent second tab of a different cell pair than the corresponding cell pair are welded to a corresponding bus bar, and the second tab and the adjacent second tab bridge one of the compressible layers and thermal barriers.

5. The battery pack of claim 1, wherein the cells are arranged in series.

6. The battery pack of claim 1, wherein the battery pack further comprises a frame integral with the thermal barriers.

7. The battery pack of claim 6, wherein the frame includes a plurality of frame subunits each housing a cell packet of the cell stack.

8. The battery pack of claim 7, wherein each cell packet includes two cell pairs and one of the compressible layers interposed between the two cell pairs.

9. A method of manufacturing a battery pack, comprising:
stacking cells having tabs into one or more cell pairs;
pre-assembly welding at least some of the tabs directly to each other;
assembling the cell pairs with a frame; and
post-assembly welding remaining unwelded tabs.

10. The method of claim 9, wherein post-assembly welding includes welding the remaining unwelded tabs directly to each other.

11. The method of claim 9, wherein post-assembly welding includes welding the remaining unwelded tabs to corresponding bus bars.

12. The method of claim 9, wherein assembling the cell pairs with the frame includes:
assembling two or more subassemblies, each subassembly comprising a frame subunit housing a cell packet including one or more of the cell pairs; and
interconnecting the frame subunits.

13. The method of claim 9, wherein the cell pairs are arranged in cell packets each including two cell pairs and a compressible layer interposed therebetween.

14. A battery pack, comprising:
a frame; and
a cell stack housed within the frame, the cell stack including:
a plurality of cells having first tabs on a first side of the cell stack and second tabs on a second side of the cell stack opposite the first side, wherein the cells are grouped only in pairs; and
compressible layers and thermal barriers stacked with the pairs, wherein the first tabs couple cells within corresponding cell pairs and do not protrude from the frame, and the second tabs protrude from the frame and bridge the compressible layers and thermal barriers to couple cells of different cell pairs.

15. The battery pack of claim 14, wherein the first tabs are directly welded to each other without bus bars.

16. The battery pack of claim 14, wherein the second tabs are directly welded to each other without bus bars.

17. The battery pack of claim 14, wherein the second tabs are welded to corresponding bus bars.

18. The battery pack of claim 14, wherein the frame is ladder shaped and comprises a plurality of frame subunits integral with the thermal barriers.

19. The battery pack of claim 14, wherein the frame comprises venting windows and tab openings at the second side.

20. The battery pack of claim 14, wherein each cell pair is interposed between one of the compressible layers and one of the thermal barriers, or between two of the compressible layers.
